(19) United States
(12) Patent Application Publication
(10) Pub. No.: US 2026/0350650 A1
(43) Pub. Date: Nov. 5, 2026

(54) METHOD AND SYSTEM TO FACILITATE PRICE PRESENTATION TO CONSUMER REGARDING HOME IMPROVEMENT PROJECT

(71) Applicant: One Click Contractor, Inc., Appleton, WI (US)

(72) Inventors: Justin A. Hatcher, Oshkosh, WI (US); Joseph F. Moran, Appleton, WI (US); Christopher T. Thornberry, Avon, IN (US); Aaron L. Bond, Port Saint Lucie, FL (US)

(73) Assignee: One Click Contractor, Inc., Appleton, WI (US)

(21) Appl. No.: 19/743,146

(22) Filed: Jul. 15, 2026

Related U.S. Application Data
(63) Continuation-in-part of application No. 19/024,913, filed on Jan. 16, 2025.
(60) Provisional application No. 63/621,738, filed on Jan. 17, 2024.
(60) Provisional application No. 63/879,384, filed on Sep. 10, 2025.

(51) Int. Cl. G06Q 30/0238

(52) U.S. Cl. CPC G06Q 30/0238

(57) ABSTRACT

Methods and systems for facilitating sales to consumers in relation to home improvement projects are disclosed herein, including methods and systems that facilitate pricing presentations. In an example embodiment, one such method includes providing a first computer operated by a contractor company, and receiving first input information from a sales representative user concerning an estimate or scope of a home improvement project. The method further includes determining a plurality of pricing/payment options, causing the pricing/payment options to be presented on a screen of either the first computer or a second computer operated by a consumer, receiving second input information indicating that the consumer has agreed to a first one of the pricing/payment options, and taking at least one action to finalize an agreement relating to a sale concerning the home improvement project, where the agreement is based at least in part upon the first one of the pricing/payment options.

### CROSS-REFERENCE TO RELATED APPLICATIONS

The present application claims the benefit of U.S. provisional patent application no. 63/879,384 entitled “Method and System to Facilitate Price Presentation to Consumer Regarding Home Improvement Project” filed on Sep. 10, 2025; and, the present application is a continuation-in-part of U.S. patent application Ser. No. 19/024,913 filed on Jan. 16, 2025, which claims the benefit of U.S. provisional patent application no. 63/621,738 filed on Jan. 17, 2024 and entitled “Method and System to Fund Home Improvement Project of a Consumer”. The contents of each of these applications are incorporated by reference herein.

### FIELD

The present disclosure relates to methods and systems for facilitating sales to consumers and, more particularly, relates to methods and systems for facilitating the presentation of pricing information or options to consumers during sales efforts, such as sales efforts relating to home improvement projects.

### BACKGROUND

To be successful as a salesperson/employee of a home improvement contractor, it is often important or critical that the salesperson employee be able to take a project from pricing to a sale. Yet conventional sales processes in this regard often are burdensome for salespersons/employees, in manners that detract from the success of those salespersons/employees in terms of closing sales.

For example, in many conventional home improvement sales contexts, when a sales representative is selling and presenting a price to a customer, the sales representative is really juggling a number of different responsibilities. Among other things, a sales representative may be trying to keep the customer engaged, trying to remember the sales process and what the sales representative has been trained to do (e.g., was it a 5% discount, then a 10% discount first?), and trying to actually calculate an appropriate discount and come up with the correct price. Additionally, from the price, the sales representative may be trying to remember if it is only possible to do a 6 month “same as cash” option or if the current ones are 12 months, on top of calculating and determining appropriate payment range amounts. It is often difficult for sales representatives to perform all of these tasks in a manner that is consistent, repeatable, compliant, and presented professionally to a given customer, and in a manner that helps the customer to understand his or her options and make a decision.

For at least one or more of these reasons, or one or more other reasons, it would be advantageous if new or improved systems and methods could be developed for facilitating sales processes, in the contexts of home improvement projects or otherwise, to alleviate one or more of the above-described challenges, to provide one or more benefits, or for one or more other reasons.

### SUMMARY

The present disclosure is intended to encompass a variety of embodiments of systems and methods for facilitating sales to consumers, including methods and systems for facilitating the presentation of pricing information or options to consumers during sales efforts, such as sales efforts relating to home improvement projects. In at least some such embodiments, upon pricing or payment options being agreed upon, the methods and systems also include taking actions to facilitate obtaining financing for such transactions.

In a first example embodiment, the present disclosure relates to a method for facilitating a sale concerning a home improvement project of interest to a first consumer. The method includes providing a first computer including at least one processing device and at least one memory device, where the first computer is operated by a contractor company and is configured to communicate with one or more other computers by at least one internet-based communication link. Additionally, the method includes receiving first input information from a sales representative user at the first computer concerning an estimate or scope of the home improvement project, determining a plurality of pricing or payment options based upon the first input information, and causing the plurality of pricing or payment options to be presented on a screen of either the first computer or a second computer operated by the first consumer. Further, the method includes receiving second input information indicating that the first consumer has agreed to a first one of the pricing or payment options of the plurality of pricing or payment options, and taking at least one action to finalize an agreement relating to the sale concerning the home improvement project, where the agreement is based at least in part upon the first one of the pricing or payment options.

In a second example embodiment, the present disclosure relates to a system for facilitating a sale concerning a home improvement project of interest to a first consumer. The system includes at least one contractor computer including a sales management computer having a first processing device and a first memory device, and a sales representative computer having a second processing device and a second memory device, where the sales management computer and sales representative computer are configured to engage in communications therebetween, and where the sales representative computer includes a video display. Further, the system includes at least one communication linkage by which the at least one contractor computer is configured to communicate with additional computers including at least one consumer computer and at least one lending company computer. The sales management computer is programmed to include a sales management configuration, and configured to communicate either the sales management configuration or instructions based upon the sales management configuration for receipt by the sales representative computer. Additionally, the sales representative computer is configured to display on the video display, in accordance with the sales management configuration or the instructions based upon the sales management configuration, a plurality of screen images to facilitate the sale concerning the home improvement project.

Notwithstanding any particular examples presented herein, the present invention is intended to encompass a variety of other embodiments including for example other embodiments as are described in further detail below as well as other embodiments that are within the scope of the claims set forth herein.

### BRIEF DESCRIPTION OF THE DRAWINGS

Embodiments of the disclosure are disclosed with reference to the accompanying drawings and are for illustrative purposes only. The disclosure is not limited in its application to the details of assembly or arrangements of components, or orderings of process steps, illustrated in the drawings. The disclosure is capable of other embodiments or of being practiced or carried out in other various manners. In the drawings:

FIG. 1 is a block diagram showing a system for facilitating sales to consumers and more particularly presenting pricing information or options to consumers as part of those sales efforts, in the context of home improvement projects, and additionally for facilitating lending in regard to such home improvement projects, in accordance with an example embodiment encompassed herein;

FIG. 2 is a block diagram showing, in schematic form, a computer as can be implemented in the system of FIG. 1;

FIG. 3 is a flow chart showing example steps of a first example method of facilitating sales to consumers that includes facilitating the presentation of pricing information or options to consumers as part of those sales efforts, in the context of home improvement projects, and additionally for facilitating lending in at least some circumstances in regard to such home improvement projects, as can be performed at least partly by the system of FIG. 1, in accordance with an example embodiment encompassed herein; and

FIG. 4, FIG. 5, FIG. 6, FIG. 7, FIG. 8, FIG. 9, FIG. 10, FIG. 11, and FIG. 12 show example screen images that can be presented by the example system of FIG. 1 during operation in accordance with the example method of FIG. 3.

The drawings show some but not all embodiments. The elements depicted in the drawings are illustrative and not necessarily to scale, and the same (or similar) reference numbers denote the same (or similar) features throughout the drawings, though all the same (or similar) features are not always separately numbered to help avoid over numbering and obscuring what the drawings are disclosing.

### DETAILED DESCRIPTION

The present inventors have recognized that there exists a need for an improved system and/or method for facilitating the sales process in the context of home improvement projects of consumers, particularly by facilitating or enhancing the presentation of pricing information or options to consumers or customers during such sales processes. Indeed, the present inventors have recognized that, when selling, it is important that a sales representative can continue to stay engaged with the customer (or keep the customer engaged) and can be able to deliver information of various types to the customer in an effective manner, for example, in a manner that is consistent, repeatable, compliant, and professionally-presented, and/or in a manner that is helpful to the customer in terms of understanding his or her options and making a decision. The present inventors have further recognized that, when selling, it is particularly important that a sales representative be able to deliver, in an effective manner as described above, pricing information of any of a variety of types, including discounting information or pricing-related options (e.g., timetable for payment), and/or possibly other options available to the customer as well. Additionally in this regard, the present inventors have recognized that it would be beneficial for facilitating such sales processes if the presentation process related to pricing or options (or related to other types of information) can be streamlined.

With at least these considerations in mind, the present disclosure envisions systems and methods, and associated functionality, that provides pricing information and options in an enhanced manner. In at least some such embodiments, sales management creates and maintains a streamlined and guardrail enforced sales method or process that all members of the team (e.g., sales representatives who are seasoned veterans as well as new sales representatives) must follow. The sales process allows the sales representative (or users) to communicate paths to affordability when interacting with homeowners, while maintaining (or operating within) the guard rails established by sales management (e.g., in terms of a workflow prescribed by sales management). Further, in at least some embodiments, the sales process also allows sales representatives to reach out for help and to ask for and (at least sometimes) obtain approval for exceptions to that prescribed workflow. Additionally, in at least some embodiments, the sales process further is coupled with a consumer lending process such that, upon a pricing decision being arrived at for a project in which financing is desired, then the process can further entail a consumer lending process.

### Example System for Facilitating Sales, Including Price/Options Presentation

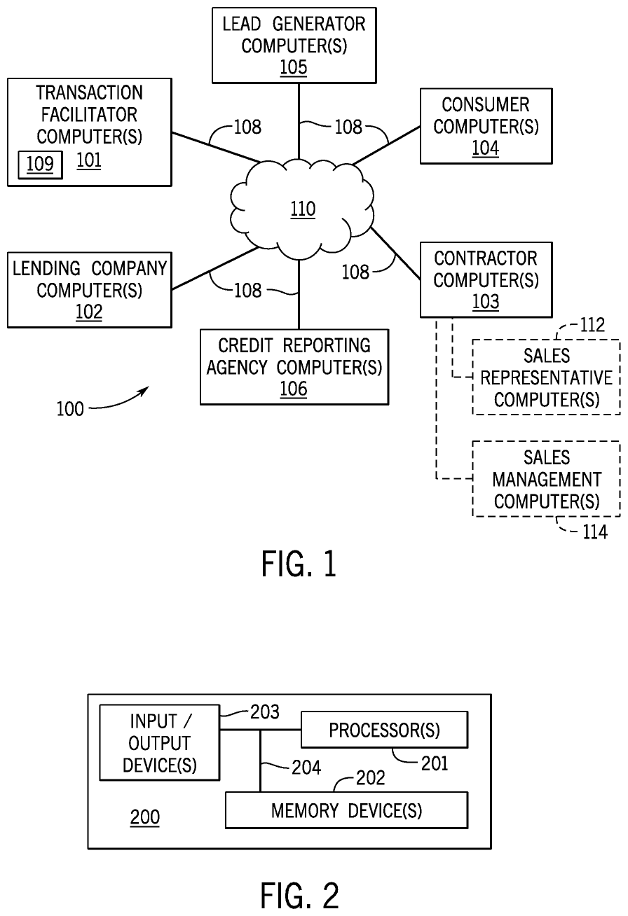

Referring to FIG. 1, a block diagram is provided to represent a system 100 that, in accordance with an example embodiment encompassed herein, is for facilitating sales by sales representatives to consumers in regard to the consumers' home improvement projects. In the present example embodiment, the system 100 particularly is configured to facilitate such sales by providing pricing information or options to the consumers in one or more enhanced manners. Further in the present embodiment, the system 100, in addition to facilitating such sales efforts, also is for facilitating consumer lending in regard to such home improvement projects upon the sales efforts concluding that financing is appropriate or desired to complete or fulfill the sale.

In the present embodiment, the system 100 includes numerous computers (or computer systems) associated respectively with different parties, respectively. Each of the parties with which the respective computers are associated can be an individual (human being) or a company or other entity that owns, operates, controls, or otherwise is associated with the respective computer. Although the system 100 is shown to include multiple interconnected computers, it should further be appreciated that the system 100 is generally intended to be representative of a variety of connections or arrangements that can be established (and interactions that can occur or be performed) among various parties, where such interactions at least partly (or entirely) involve communications among the various computers respectively associated with the respective parties, to achieve or facilitate sales, to provide pricing information or options to consumers, and/or to achieve or facilitate consumer lending, in regard to home improvement projects.

More particularly as illustrated, the system 100 includes each of one or more transaction facilitator computer(s) 101, one or more lending company computer(s) 102, one or more contractor computer(s) 103, one or more consumer computer(s) 104, one or more lead generator computer(s) 105, and one or more credit reporting agency computer(s) 106. Although the system 100 is shown in FIG. 1 to include one or more of each of the types of computers 101, 102, 103, 104, 105, and 106, depending upon the embodiment one or more of these types of computers need not be present. For example, in some embodiments, one or more lead generator computer(s) 105 need not be included as part of the system 100. Also, in other embodiments, one or more other types of computer(s) other than those shown in FIG. 1 can additionally or instead be present. Further, as described below, in at least some embodiments encompassed herein, at least one (or possibly more than one, or each) of the transaction facilitator computer(s) 101 respectively includes and operates partly based upon a respective large-scale least recently used (LRU) cache (or cache memory) 109.

In at least some embodiments encompassed herein, methods of facilitating sales, which can include methods of facilitating presentations regarding pricing or options available to consumers, particularly can be performed by the one or more contractor computer(s) 103. Further with respect to FIG. 1, as represented in dashed lines, the one or more contractor computer(s) 103 can, depending upon the embodiment or implementation, include one or more sales representative computer(s) (or sales representative contractor computer(s)) 112, and/or one or more sales management computer(s) (or sales management contractor computer(s)) 114, which can be collectively referred to as sales computer(s). The one or more sales representative computer(s) 112 can be operated/utilized, for example, by one or more sales representatives or other contractor employees who are interacting with consumers/customers (e.g., in the field, or at a consumer home or work site). The one or more sales management computer(s) 114 can be operated/utilized, for example, by one or more managers who are determining or setting sales procedures or policies to be followed by sales representatives or other contractor employees (e.g., at a corporate office). Although in the present example embodiment of FIG. 1 the sales computer(s) and any associated method(s) are included or hosted by the contractor computer(s) 103 as may be desired in at least some embodiments, in alternate embodiments encompassed herein one or more of the sales computer(s) (including one or more of the sales representative computer(s) 112 and/or the sales management computer(s) 114) and/or any associated method(s) can be included or hosted by any of the other ones of the computer(s) 101, 102, 104, 105 and 106.

Although FIG. 1 is intended to be representative of embodiments or implementations in which there are both the one or more sales representative computer(s) 112 and the one or more sales management computer(s) 114, FIG. 1 is also intended to be representative of embodiments or implementations in which there are only one or more of the sales representative computer(s) 112, or only one or more of the sales management computer(s) 114, or only the one or more contractor computer(s) 103 that are not necessarily either sales representative computer(s) or sales management computer(s) 114. Additionally, in some embodiments or implementation encompassed herein, a single one of (or each one of several of) of the contractor computer(s) 103 can serve both of the roles of a sales representative computer and a sales management computer.

Additionally as shown in FIG. 1, the system 100 is one in which the transaction facilitator computer(s) 101, lending company computer(s) 102, contractor computer(s) 103, consumer computer(s) 104, lead generator computer(s) 105, and credit reporting agency computer(s) 106 engage in communications with one another by way of the internet or World Wide Web (WWW) 110. The computers 101, 102, 103, 104, 105, and 106 can be connected to the internet (or WWW) 110 by way of one or more additional communication links 108. To the extent that the one or more contractor computer(s) 103 include both one(s) of the sales representative computer(s) 112 and one(s) of the sales management computer(s) 114, those different sales representative computer(s) and sales management computer(s) 114 also can communicate with one another by way of the WWW 110 and/or one or more of the additional communication links 108. The additional communication links 108 can be, but need not be, considered part of the internet (or WWW) 110. Notwithstanding the manner in which the additional communication links 108 are shown in FIG. 1, it should be understood that the additional communication links 108 are representative of any arbitrary number of additional communication links that can be present depending upon the embodiment. Also, in other embodiments encompassed herein, one or more of the computer(s) 101, 102, 103, 104, 105, and 106, including any related computer(s) (for example, the sales representative computer(s) 112 and sales management computer(s) 114 of the contractor computer(s) 103), can be in communication with one another by way of communication links that do not involve the internet (or WWW) 110, such as Ethernet links, intranet links, satellite links, or other communication links.

Indeed, the present disclosure generally envisions and encompasses any of a variety of embodiments in which any of the computers 101, 102, 103, 104, 105, and 106, including any related computer(s) (for example, the sales representative computer(s) 112 and sales management computer(s) 114 of the contractor computer(s) 103), engage in communications with one another by way of any of a variety of communication links or media, including communication links or media that involve the internet (or WWW) as well as communication links or media other than, or in addition to, internet-based communication links or media. Further for example, the communication links or media that can be employed in various embodiments can include any of a variety of wired or wireless communication links or media involving electrical cables such as coaxial cables, fiber optics or other optical communications media or technologies, digital subscriber lines (DSLs), cellular technologies (e.g., 3G, 4G, 5G, or 6G), Bluetooth communications, Wi-Fi communications, radio wave, satellite, microwave, infrared, or other wired or wireless communications technologies.

It should be appreciated that at least some methods encompassed herein relate particularly to methods of facilitating sales, or to (or which can include) methods of facilitating pricing presentations and/or facilitating presentations regarding other options available to consumers (or customers). Some such methods may be performed in combination with methods of consumer lending as combination methods, and such combination methods can involve interactions/communications among numerous ones of the computers 101, 102, 103, 104, 105, and 106, including any related computer(s) (for example, the sales representative computer(s) 112 and sales management computer(s) 114 of the contractor computer(s) 103).

However, other methods encompassed herein that relate particularly to the aforementioned methods of facilitating sales or to methods of facilitating presentations regarding pricing or other options available to consumers (alone or in combination with methods of consumer lending) may only involve interactions/communications between two (or a limited number) of the various ones of the computers 101, 102, 103, 104, 105, and 106. Indeed, in some such embodiments or implementations, such other methods may only involve interactions/communications between two of the contractor computer(s) 103 or may be performed by a single one of the contactor computer(s). For example, one of the sales management computers 114 may provide directions to one of the sales representative computer(s) 112 or, alternatively, one of the sales representative computer(s) 112 by itself will perform the entire method of facilitating sales including a method of facilitating (or providing) a pricing presentation. The present disclosure is intended to encompass all such varied embodiments and implementations.

Referring additionally to FIG. 2, in at least some embodiments encompassed herein, each of the transaction facilitator computer(s) 101, lending company computer(s) 102, contractor computer(s) 103, consumer computer(s) 104, lead generator computer(s) 105, and credit reporting agency computer(s) 106, including any related computer(s) (for example, each of the sales representative computer(s) 112 and sales management computer(s) 114 of the contractor computer(s) 103), can be generally understood as taking the form of a computer 200. As shown schematically by a block diagram provided in FIG. 2, the computer 200 includes one or more processor(s) (or processing device(s)) 201, one or more memory (or storage) device(s) 202, and one or more input and/or output (I/O) device(s) 203. Additionally as shown, the processor(s) 201, memory device(s) 202, and I/O device(s) 203 are in communication with one another, directly or indirectly, by way of one or more internal communication link(s) 204.

Each of the one or more processor(s) 201 (simply referred to as the processor(s) 201 below) can take any of a variety of forms depending upon the embodiment, and can include any of a variety of one or more systems, devices, or components that perform any of a variety of types of processing or calculation operations. For example, depending upon the embodiment, the processor(s) 201 can respectively be implemented by way of respective hardware devices or components, firmware, or software (including applications or apps) implemented upon hardware encompassed by the processors. Also for example, the processor(s) 201 can be or include one or more microprocessors, one or more microcomputers, or one or more other forms of processing devices such as application specific integrated circuits (ASICs) or programmable logic devices (PLDs). The processor(s) 201 can be operated in accordance with various programs or computer-executable instructions so as to perform any of a variety of different functions related to the performing of processing and taking of other actions as described herein, including actions that achieve or facilitate sales, achieve or facilitate the providing of presentations regarding pricing or other options available to consumers, or achieve or facilitate consumer lending or funding for home improvement projects in other manners.

Additionally, the one or more memory device(s) 202 (simply referred to as the memory device(s) 202 below) can store any of a variety of types of information or data depending upon the embodiment or implementation. Among other things, the memory device(s) 202 can store software, programs, applications (or apps), or computer-executable instructions in accordance with which one or more of the processor(s) 201 operate. Also, as described further herein, the memory device(s) 202 can store any of a variety of information or data, including customer identification or contact (e.g., home/residence/work address, phone number, or email address) information or data, financial information or data, home improvement project description information or data, and/or other types of information or data. Further, the memory device(s) 202 can store additional information or data that is based upon or derived from (e.g., by performing processing) any of such types (or other types) of information or data.

The memory device(s) 202 can take any of a variety of forms or encompass any of a variety of different types of systems, devices, or components depending upon the embodiment. For example, in some embodiments, any one or more of the memory device(s) 202 can employ any of databases, magnetic disk storage, optical disk storage, random access memory (RAM) devices, read only memory (ROM) devices, compact disc read only memory (CD/ROM) devices, electrically erasable programmable read only memory (EEPROM) devices, or other forms of storage devices or computer-readable storage media. In some embodiments, the processing and memory functionality associated with the processor(s) 201 and memory device(s) 202 of any one or more of the transaction facilitator computer(s) 101, lending company computer(s) 102, contractor computer(s) 103, consumer computer(s) 104, lead generator computer(s) 105, and credit reporting agency computer(s) 106, including any related computer(s) (for example, 112 and 114 of computer(s) 103), can take the form of a single device that has both processing and memory capabilities (e.g., a processor-in-memory or PIM). Also, in at least some embodiments encompassed herein, one or more of the transaction facilitator computer(s) 101 can store data or information in one more cache memories. The large-scale LRU cache 109 mentioned above with reference to FIG. 1 should therefore be considered to be included as one of the memory device(s) 202 of FIG. 2.

In at least some embodiments, with respect to any of the transaction facilitator computer(s) 101, lending company computer(s) 102, contractor computer(s) 103, consumer computer(s) 104, lead generator computer(s) 105, and credit reporting agency computer(s) 106, including any related computer(s) (for example, any of the sales representative computer(s) 112 and sales management computer(s) 114 of the contractor computer(s) 103), one or both of the processing or memory functionality provided by the processor(s) 201 and/or memory device(s) 202 of the respective computer can be provided by way of multiple processing and/or memory systems, devices, or components that are located in a variety of physical locations or distributed among a variety of systems, or subsystems. Among other things, in at least some embodiments encompassed herein, one or more of the processor(s) and/or memory device(s) of any of the computer(s) 101, 102, 103, 104, 105, and 106, including any related computer(s) (for example, any of the sales representative computer(s) 112 and sales management computer(s) 114 of the contractor computer(s) 103), can be provided in or by a cloud computing system (e.g., implemented in the cloud) formed from or encompassing numerous processors and memory devices respectively located apart from one another (or distributed) at many separate and distinct locations.

Further with reference to FIG. 2, the I/O device(s) 203 can include any of a variety of systems, devices, or components that permit signals or information to be input to (for receipt by) the computer 200 from, or output from the computer 200 for receipt by, one or more other computers, systems, devices, or components, or individuals (e.g., people interfacing with the computer 200). The I/O device(s) 203 permit the computer 200 to intercommunicate or interact with other computers, systems, devices, or components, or individuals. More particularly, the I/O device(s) 203 can for example include terminals or ports, wireless transceivers or Wi-Fi hotspots that facilitate wireless communications, and/or devices such as video displays or monitors, touch screens, keyboards, joysticks, mouse devices, microphones, and speakers. The I/O device(s) 203 can be located at the same or substantially the same locations as the processor(s) 201 and/or memory device(s) 202 of the computer 200, but also can be located remotely from the processor(s) 201 and/or memory device(s) 202 of the computer.

Further, it should be recognized that the computer 200 of FIG. 2 is representative of a variety of different types of computers (or computer devices or computer systems) that can be implemented depending upon the circumstance or embodiment. Such different types of computers represented by the computer 200 can include, for example, personal computers such as laptop, notebook, or desktop computers, or mobile devices such as smart phones, cellular telephones, hand held devices or handsets, smart wristwatches, or other mobile computing devices, mainframe computers, or computers associated with cloud computing systems. It should also be recognized that different ones of the computers 101, 102, 103, 104, 105, and 106, including any related computer(s) (for example, any of the sales representative computer(s) 112 and sales management computer(s) 114 of the contractor computer(s) 103), can respectively be of, or encompass multiple different computers of, these different types. For example, in some embodiments, some of the computer(s) 101, 102, 103, 104, 105, and 106, including any related computer(s) (for example, any of the sales representative computer(s) 112 and sales management computer(s) 114 of the contractor computer(s) 103), can be desktop or laptop computers, or mainframe computers, and others of the computer(s) 101, 102, 103, 104, 105, and 106, including any related computer(s) (for example, any of the sales representative computer(s) 112 and sales management computer(s) 114 of the contractor computer(s) 103), can be mobile devices.

Further for example, in at least some example embodiments, each of the consumer computer(s) 104 can respectively be a respective mobile device and/or a respective laptop, notebook, or desktop computer that is respectively operated by and associated with (e.g., owned by) a respective consumer who is seeking assistance with implementing one or more home improvement project(s). Also for example, each of the contractor computer(s) 103, including any related computer(s) (for example, any of the sales representative computer(s) 112 and sales management computer(s) 114 of the contractor computer(s) 103), can respectively be a respective mobile device and/or a respective laptop, notebook, or desktop computer that is respectively operated by and associated with (e.g., owned by) a respective contractor who is seeking to assist one or more consumer(s) with implementing one or more home improvement project(s). Additionally for example, respective ones of the lending company computer(s) 102 can respectively be large computer(s) (e.g., mainframe computer(s)) of lending companies such as banks or other financial institutions that can provide loans (for example, credit unions), and likewise respective ones of the credit reporting agency computer(s) 106 can respectively be large computer(s) (e.g., mainframe computer(s)) of credit reporting agencies such as Equifax of Atlanta, Georgia, TransUnion of Chicago, Illinois, or Experian plc of Dublin, Ireland.

Further with respect to FIG. 1 and FIG. 2, in at least some embodiments encompassed herein, one or more of (or any of) the transaction facilitator computer(s) 101, lending company computer(s) 102, contractor computer(s) 103, consumer computer(s) 104, lead generator computer(s) 105, and credit reporting agency computer(s) 106, including any related computer(s) (for example, any of the sales representative computer(s) 112 and sales management computer(s) 114 of the contractor computer(s) 103), can interact with one or more others of these computers in accordance with a client-server model or architecture. Additionally for example, in at least some embodiments encompassed herein, one or more of the computers 101, 102, 103, 104, 105, and 106, including any related computer(s) (for example, any of the sales representative computer(s) 112 and sales management computer(s) 114 of the contractor computer(s) 103), can interact with one or more others of these computers in a peer-to-peer manner.

Further for example, in at least some embodiments encompassed herein, the one or more transaction facilitator computer(s) 101 includes a first one of the transaction facilitator computer(s) that is or includes a server computer. As interactions occur between consumer(s) and contractor(s) who are seeking to implement, and achieve funding of, home improvement projects, communications and interactions occur between one(s) of the contractor computer(s) 103 and one(s) of the consumer computer(s) 104. In turn, one or more of the contractor computer(s) 103 and/or one or more of the consumer computer(s) 104 can engage, as client computer(s), in communications and interactions with the first transaction facilitator computer (which again in this example is or includes a server computer), in an effort to facilitate sale(s) or presentations regarding pricing or other options, or to obtain funding for the home improvement projects. Those ones of the contractor computer(s) 103 and the consumer computer(s) 104 which engage in communications or interactions with the first one of the transaction facilitator computer(s) 101 can do so in accordance with a client-server model of communications. In contrast, in at least some such embodiments, the transaction facilitator computer(s) 101 can engage in communications and interactions with the lending company computer(s) 102 and/or the credit reporting agency computer(s) 106 on a peer-to-peer basis.

### Example Method of Facilitating Sales, Including Pricing Presentation

The present disclosure envisions numerous different methods of operation and use cases in which embodiments of systems encompassed herein such as the system 100 of FIG. 1 are employed to achieve, or facilitate the achieving of, sales relating to home improvement projects. In at least some embodiments encompassed herein, the method facilitates sales at least in part by facilitating pricing (or price) presentation(s), or facilitating presentation(s) regarding other options, to consumers. Also, in at least some embodiments encompassed herein, upon determining that a sale will involve a pricing option that entails financing, additional steps are performed that facilitate a consumer lending process, such as any of the methods described in U.S. Patent Application Publication No. 2025/0232368, published on Jul. 17, 2025 and entitled “Method and System to Fund Home Improvement Project of a Consumer” (which is a published version of U.S. patent application Ser. No. 19/024,913 filed on Jan. 16, 2025), which is hereby incorporated by reference herein.

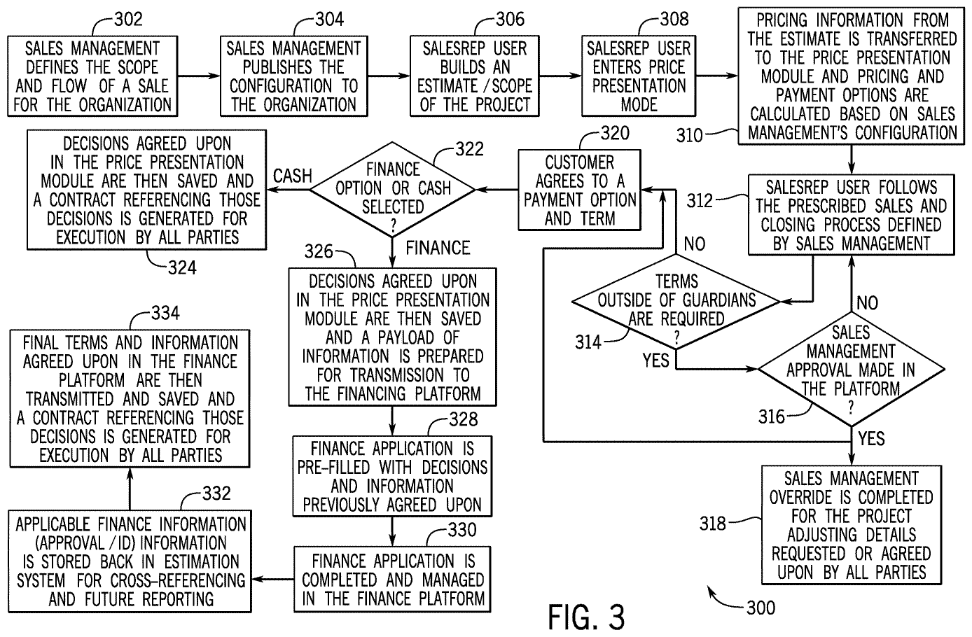

Referring particularly to FIG. 3, a high-level flow chart 300 is provided to illustrate one example method of operation encompassed by the present disclosure, which includes a method of price presentation. As shown, the method represented by the flow chart 300 begins at a first step 302, at which sales management defines the scope and flow of a sale (or “sales management configuration” or “sales rubric”) for the organization, which in the present example embodiment is a contractor company. The scope and flow of a sale (or sales management configuration) can include a representation of (or a set of rules or guidelines for) a sales process, including in at least some embodiments one or more requirements, metrics, or benchmarks to be satisfied. In the present example, the first step 302 more particularly involves sales management creating and maintaining a sales management configuration for a streamlined and guardrail enforced sales method or process that all members of the team (e.g., sales representatives who are seasoned veterans as well as new sales representatives) are supposed to (or must) follow. Such a sales management configuration in some circumstances or embodiments can include one or more types of documentation, such as a flow chart or schematic, which can be scanned in or otherwise uploaded into the memory device(s) 202, for example, of one or more of the sales management computer(s) 114. Also, in some circumstances or embodiments, the sales management configuration can take the form of a software program or system such as a workflow management system, which is programmed into the memory device(s) 202, for example, of one or more of the sales management computer(s) 114.

Next, at a second step 304, the sales management publishes the configuration to the organization. More particularly, in the present example embodiment in which the organization is a contractor company, one or more of the sales management computer(s) 114 that have been provided with the sales management configuration (e.g., the documentation or software program or system forming or representing the scope and flow of the sale) can cause that sales management configuration to be output to all of the one or more of the contractor computer(s) 103 that are owned by or associated with the contractor company, and/or output to user(s) of those contractor computer(s) 103. Among other things, the sales management configuration (or the scope and flow of the sale) can be provided to one or more of the sales representative computer(s) 112 included among the contractor computer(s) 103 owned by or associated with the contractor company, which in turn can make available the sales management configuration (or scope and flow of the sale) to all sales representative(s) who are using or associated with those sales representative computer(s) 112. In some embodiments or implementation, rather than the communicating the sales management configuration from the sales management computer(s) 114 to the sales representative computer(s) 112, instead a subportion of the sales management configuration or instructions based upon (or reflective of) that sales management configuration are communicated from the sales management computer(s) 114 to the sales representative computer(s) 112.

At a third step 306, a sales representative user builds an estimate/scope of a home improvement project, typically in response to receiving a consumer (or customer) inquiry. The estimate/scope of the project can be built in accordance with the sales management configuration received at the second step 304. In at least some embodiments, building of the estimate/scope is accomplished through operation of one of the sales representative computer(s) 112 in accordance with (or response to) commands provide from the sales representative user to that computer or other interactions between that computer and the sales representative. Or, in some alternate embodiments, the estimate/scope can be entirely or partly automatically calculated or determined by operation of the sales representative computer 112 or another one of the contractor computer(s) 103, or by another one of the computers included by the system 100, or can be provided from a different source. The sales representative computer 112 or other computer(s) that operate to build the estimate/scope of the home improvement project can be considered an estimation system.

Next, at a fourth step 308, the sales representative computer 112, typically as operated in accordance with commands provided from the sales representative user, can further enter into and operate in accordance with a price presentation mode of operation. Further, at a fifth step 310, pricing information from the estimate/scope determined at the third step 306 is transferred to a price presentation module, and pricing and payment options are calculated or determined based on the sales management's configuration. In the present example embodiment, the price presentation module to which the estimated/scope is transferred can be considered a module of the sales representative computer 112. Given that the sales representative computer 112 received the sales management configuration at the second step 304, the pricing and payment options particularly are calculated in accordance with sales management configuration. Further, upon calculation or determination of the pricing and payment options, this information can be displayed by the sales representative computer 112 for viewing by the sales representative (and/or the consumer/customer, if the consumer/customer is present with the sales representative), and/or also can be transmitted from the sales representative computer 112 to the consumer computer 104 being operated by the consumer/customer, which in turn can display (or otherwise output) that pricing and payment option information.

Upon completion of the fifth step 310, the method advances to a sixth step 312, at which the sales representative user follows the prescribed sales and closing process defined by sales management. In the present embodiment, the sales representative user particularly can follow a sales and closing process that is set forth in the sales management configuration, as provided by the sales representative computer 112. The sixth step 312 can include interactions of the sales representative user with the sales representative computer 112 by which the sales representative is provided with prompts for information, in response to which the sales representative enters information, or by which the sales representative can make selections from various options, or by which (in some embodiments) the sales representative can enter various inquiries or information into the sales representative computer 112.

Performance of the sixth step 312 can also include involve the input of inquiries or information by the consumer (or customer) who is interested in making the home improvement project-related purchase, into one of the consumer computer(s) 104 associated with that consumer, as well as the providing of prompts or information to the consumer by way of the that consumer computer. The consumer computer having such interactions/communications with the consumer can also communicated with the sales representative computer 112 to allow for appropriate communications of information between the consumer computer and the sales representative computer. In other embodiments or circumstances, communications/interactions with a consumer can occur directly by interactions between the consumer and the sales representative computer 112 if the sales representative user allows for and enable such interactions, such as by allowing the consumer to provide inputs directly to the sales representative computer.

Additionally, performance of the sixth step 312 ultimately results in a tentative or proposed pricing and terms proposal relating to the home improvement project of interest. Upon such a proposed pricing and terms proposal being completed or formulated, then at a seventh step 314 it is determined by the sales representative computer 112 (or alternatively the sales management computer 114) whether terms outside of the guardrails established by the sales management configuration are required. If terms outside of the guardrails established by the sales management configuration are not required, then the method advances to a tenth step 320 as described further below. Alternatively, if terms outside of the guardrails established by the sales management configuration are required, then the method advances to an eighth step 316, at which it is determined whether an appropriate sales manager approval is made in the platform. The eighth step 316 can be performed by the sales management computer 114 providing a prompt to a sales manager user to provide an authorization of the terms in question, or automatically by the sales management computer. If no such authorization is granted or provided at the eighth step 316, then the process returns to the sixth step 312, at which a new proposed pricing and terms proposal can be generated.

Alternatively, if at the eighth step 316 the sales management computer 114 is provided with an appropriate authorization from a sales manager user in response to prompting that sales manager user indicating that the proposed terms are acceptable, or if the sales management computer automatically determines and grants such authorization, then the process advances to a ninth step 318. At the ninth step 318, upon the sales management authorization having been obtained, the sales management override is completed for the project and there can be adjusting of details of the proposal as requested or agreed upon by all of the parties. Further, upon the completion of the ninth step 318, then the method advances to the tenth step 320.

At the tenth step (regardless of whether it is arrived at directly from the seventh step 314 or subsequent to the performing of the eighth step 316 and ninth step 318), the customer agrees to, and provides an indication of agreement to, a payment option and a term. Agreement by the customer can be obtained, for example, when the customer (or consumer) provides an input to the consumer computer 104 indicating agreement, which in turn can be communicated to the sales representative computer 112 and/or to the sale management computer 114. Alternatively for example, agreement by the customer can be provided directly to the sales representative computer 112 if the customer provides an input to that computer when presented with an opportunity to do so by the sales representative user.

Upon receiving the expression of customer agreement at the tenth step 320 then, as indicated by an eleventh step 322, in the present embodiment the consumer (or customer) can also particularly specify a selection of a finance option or a cash option in terms of how payment for the home improvement project will be achieved. This selection by the consumer can be provided, for example, in any of the manners that agreement by the customer can be provided at the tenth step 320 and, indeed, can be (in at least some circumstances) provided as part of or in combination with the performance of the tenth step 320. If the cash option is selected at the eleventh step 322, then the method advances to a twelfth step 324. At the twelfth step 324, the decisions agreed upon in the price presentation module are then saved and a contract referencing those decisions is generated for execution by all of the parties (e.g., including the consumer/customer and the contractor company). The twelfth step 324 can be performed automatically by, for example, the sales management computer 114, which can send any generated contract to the sales representative computer 112, to the consumer computer 104, and/or to other recipients. Upon attainment and performance of the twelfth step 324, the method then ends.

Alternatively, if the finance option is selected at the eleventh step 322, then the method advances to a thirteenth step 326. At the thirteenth step 326, the decisions agreed upon in the price presentation module are then saved and a payload of information is prepared for transmission to a financing platform. In the present embodiment, the thirteenth step 326 can be performed by the sales representative computer 112 (or another of the contractor computer(s) 103). Additionally in the present embodiment, the financing platform to which the payload of information is to be transmitted can be a module of the sales representative computer 112. In alternate embodiments, the financing platform instead can be a module of the sales management computer 114 or even a different computer such as one of the lending company computer(s) 102.

Additionally, next at a fourteenth step 328, a finance application is pre-filled with decisions and information previously agreed upon. The finance application can be pre-filled automatically by the sales representative computer 112 or, in alternate embodiments, by the sales management computer 114 or a different computer such as one of the lending company computer(s) 102. Then, at a fifteenth step 330, the finance application is completed and managed in the financing platform. Again, the finance application can be completed and managed in response to information input to the sales representative computer 112 by a sales representative user (or a consumer or customer who has been granted access to that computer by the sales representative user), or from the consumer computer 104 to which that information has been input by the consumer applying for financing. In alternate embodiments, the finance application can be completed and managed partly or entirely automatically by the sales representative computer 112 or a different computer such as the sales management computer 114 or one of the lending company computer(s) 102.

Further, upon completion of the fifteenth step 330, the method advances to a sixteenth step 332. At the sixteenth step, applicable finance information (e.g., approval/id) information is stored back in the estimation system (which, as discussed above with respect to the third step 306, can be provided by the sales representative computer 112 or other computer(s)) for cross-referencing and future reporting. In some embodiments, the applicable finance information is utilized by the financing platform to pursue financing by way of one or more loans. In at least some embodiments or circumstances, financing particularly can be arranged by interactions between the financing platform of the sales representative computer 112 (or sales management computer 114, or other one of the contractor computer(s) 103) and one or more of the lending computer(s) 102 and/or the transaction facilitator computer(s) 101.

In at least some embodiments or implementations, the obtaining of financing can involve communication and coordination among the sales representative computer 112 and one (or more) of the transaction facilitator computer(s) 101. For example, the completed finance application can be communicated from the sales representative computer 112 to the transaction facilitator computer 101 (and the transaction facilitator company associated therewith), which then evaluates and classifies different lending option(s) that are potentially appropriate (or suitable, or viable) for the customer, for example, in view of credit report or soft credit pull results and/or possibly other information or factors. Such an evaluation and classification process can generate an ordering or ranking of two or more different lending option(s) that are appropriate (or suitable) for the customer when two or more different lending option(s) are appropriate (or suitable). Further, suitability classification for example can involve providing classification into three groups: suitable for 1st Look Lender, 2nd Look Lender, or 3rd Look Lender. Or, if merely one lending option proves to be appropriate (or suitable) for the customer, then such evaluation and classification process can result in the identification of that single lending option. Based upon that evaluation or classification process, the transaction facilitator computer 101 (or, in alternate embodiments, another computer such as the sales representative computer 112) can communicate and interact with appropriate one(s) of the lending company computer(s) 102, to apply for and secure desired loan financing. In at least some embodiments, the aforementioned evaluation or classification process regarding lenders is performed (or performed at least partly) by the large-scale LRU cache 109 shown in FIG. 1.

Additionally, in some embodiments, one of the transaction facilitator computer(s) 101 associated with (e.g., owned or operated by) a transaction facilitator company can take the form of a server computer. The server computer can for example be a Antsle one D or Antsle one XD (or XD Pro or XD Ultra) cloud server computer (or private cloud server computer) available from Antsle, Inc. of Las Vegas, Nevada. Also, in at least some embodiments, the server can be configured to operate in a virtualized manner, such as through the use of virtualization software available from VMware LLC of Palo Alto, California, and in accordance with a microservices architecture. Such virtualized operation, and microservices architecture, are desirable from the standpoint of capacity management, and allow for higher throughput (e.g., in terms of user authentication. Nevertheless, in alternate embodiments, other manners of operation and architectures can be employed by a server computer, such as (for example) a monolithic architecture.

Further, in at least some embodiments in which the transaction facilitator computer 101 takes the form of a server computer, the server computer includes (or supports therewithin) a large-scale LRU cache scale LRU cache such as the large-scale LRU cache 109 of FIG. 1. The large-scale LRU cache operates to store active dealer configuration information, application information, and lender status flags. During operation, the server computer operates to perform an evaluation and classification process at least in part by operating in accordance with (or as) an appetite engine (or appetite engine application). When operating in accordance with the appetite engine, the appetite engine pulls information from the large-scale LRU cache, particularly during building and execution phases, including the active dealer configuration information, the application information, and the lender status flags. The appetite engine, which generally operates to make decisions and causes workflow to proceed, is programmed to operate to reflect (or “knows”) generalized underwriting rules, and operates to call out to lenders to see if lenders will accept a particular loan opportunity with a given customer in the context of a given home improvement project.

Upon a financing option being identified and secured (e.g., upon an applied-for loan being approved by one of the lending companies associated with one of the lending company computer(s) 102), then at a seventeenth step 334 the final terms and information agreed upon at (or by way of) the financing platform are then transmitted and saved, and a contract referencing those decisions is generated for execution by all of the parties. The seventeenth step 334 can be performed by the sales representative computer 112, or alternatively by another computer such as the sales management computer 114. Any such contract that is generated can also be transmitted by the sales representative computer 112 (or other computer performing the seventeenth step 334) to other computers, such as the consumer computer 104 associated with the consumer who is requesting the home improvement project, or one of the lending company computers 102 involved with providing a loan or financing. Such a generated contract can thus be executed (e.g., by hand signature/wet signature or electronic signature) by all relevant parties, such as the consumer/customer requesting the home improvement project, the contractor or sales representative user, or a representative of the lending company.

Upon completion of the seventeenth step 334, the method as shown in FIG. 3 ends. Nevertheless, in alternate embodiments, additional steps can be performed or the method can be repeated with respect to additional home improvement projects of interest to the same consumer or other consumer(s).

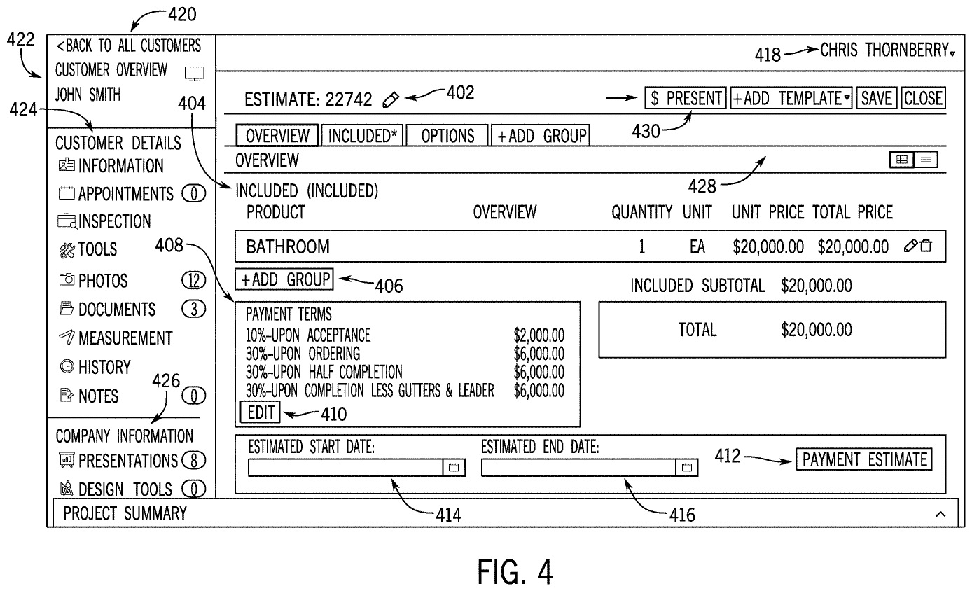

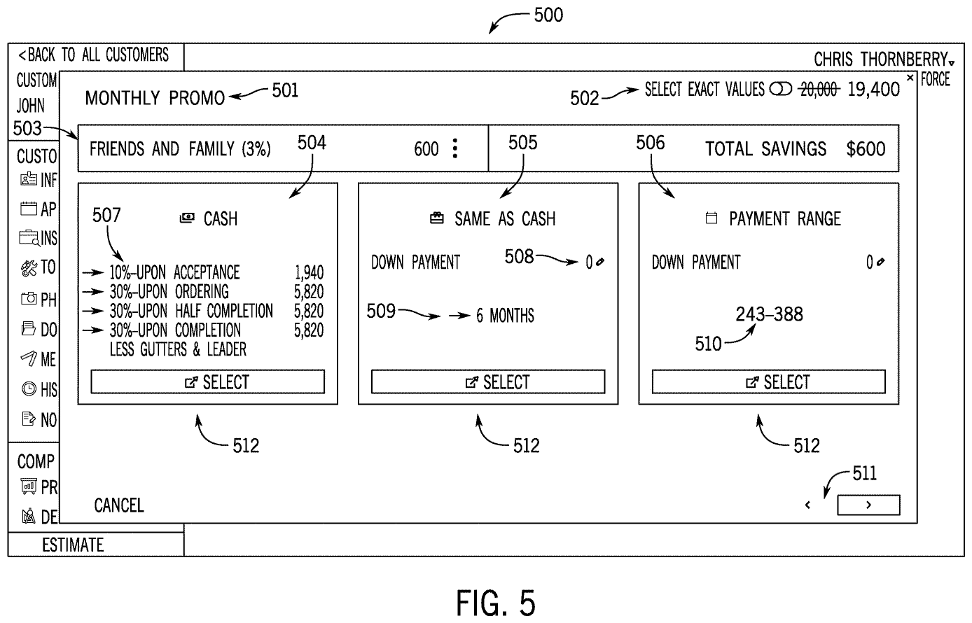

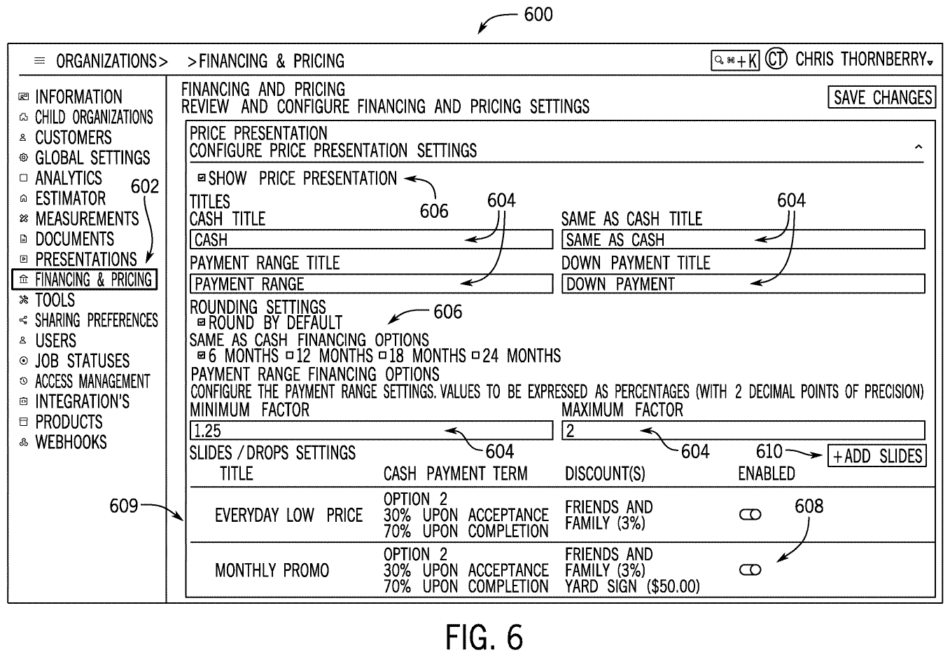

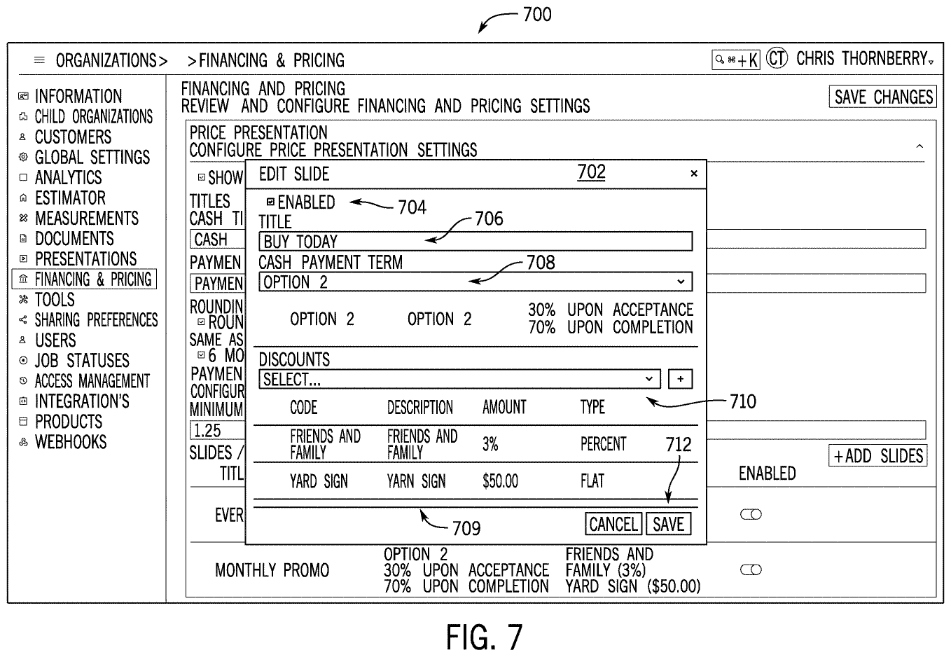

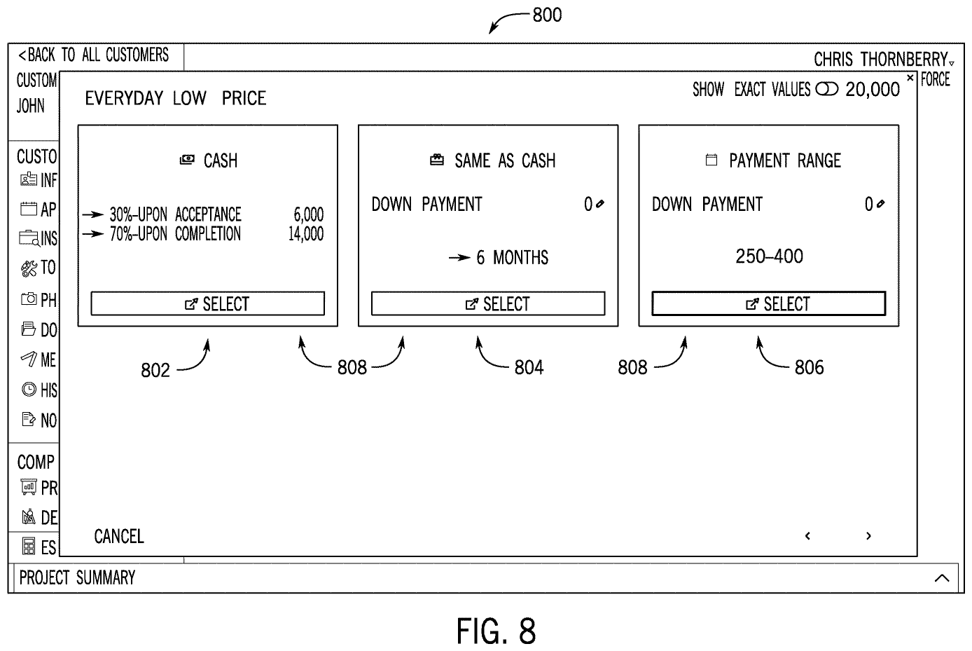

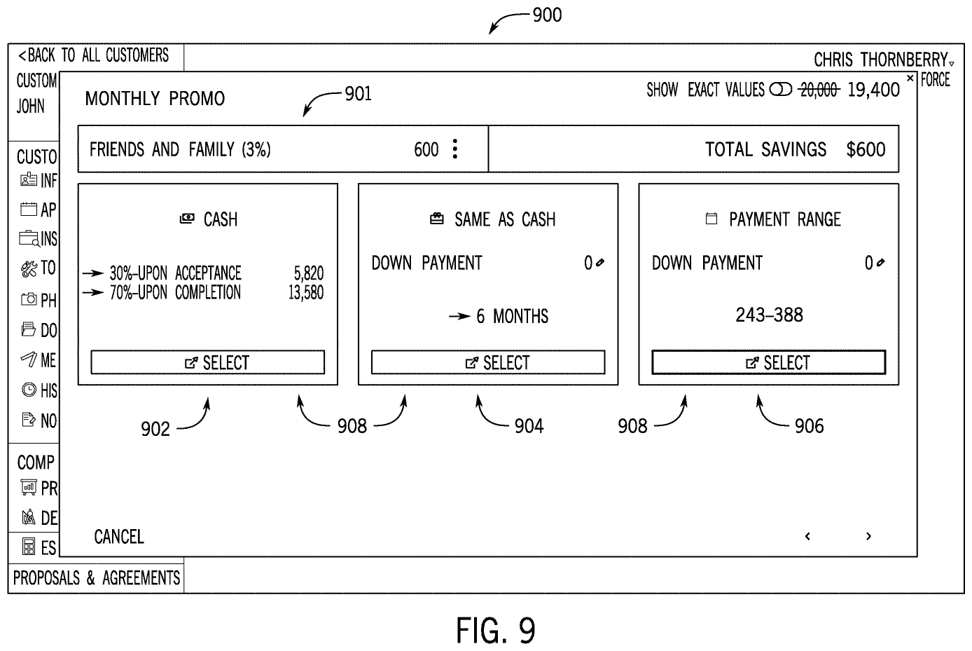

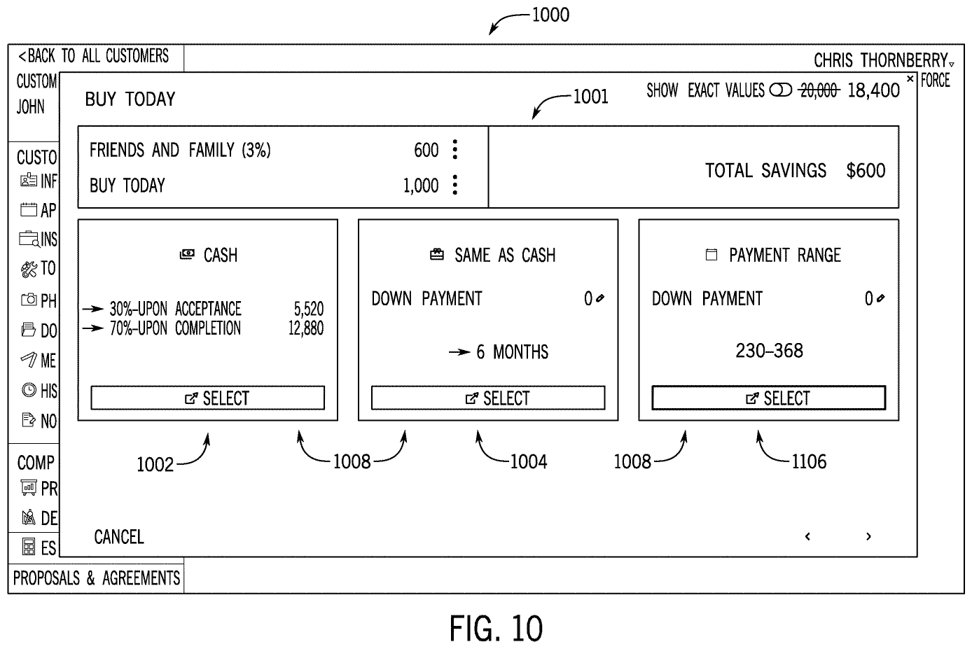

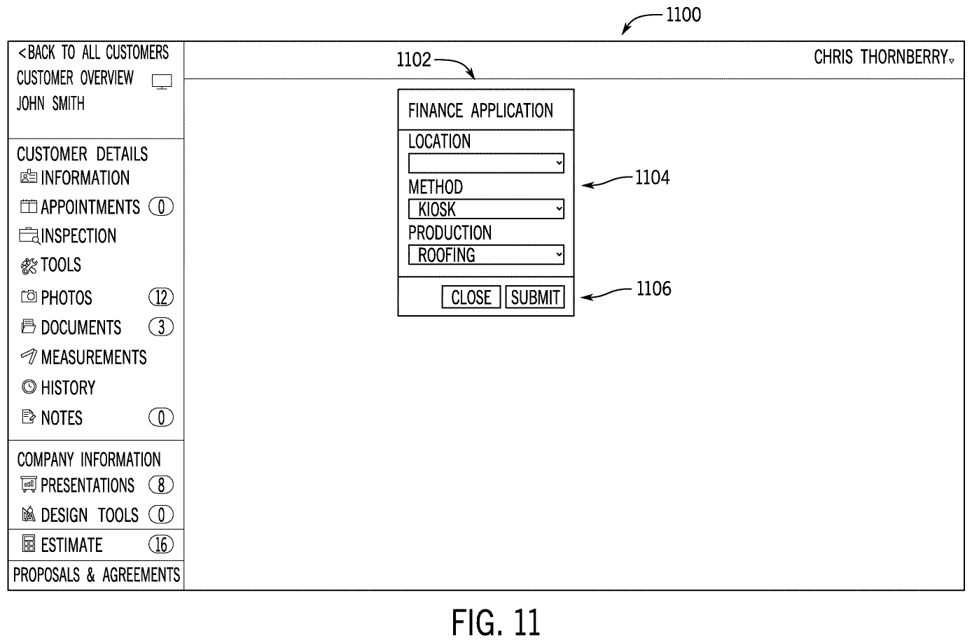

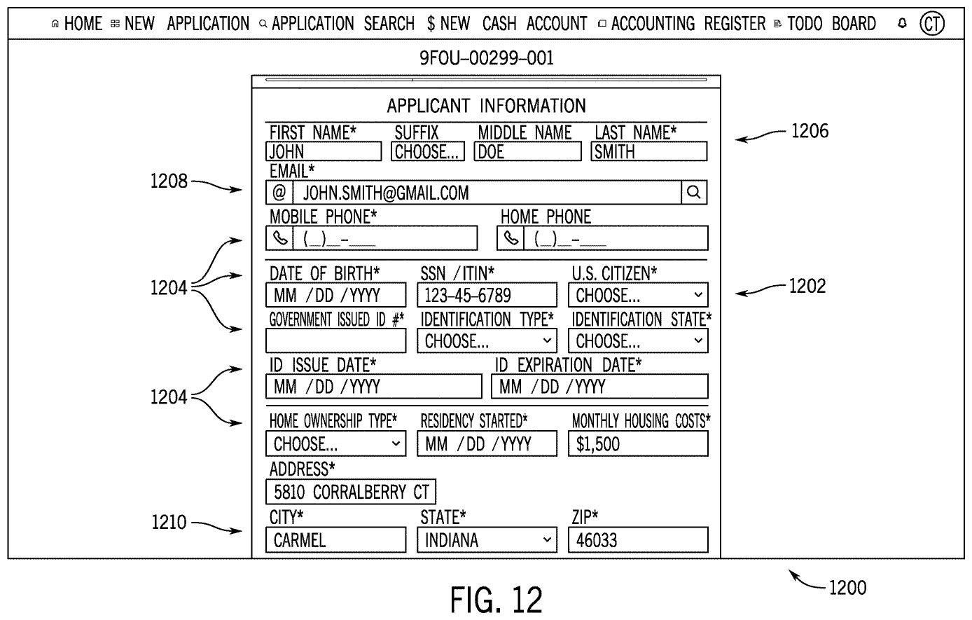

Turning to FIG. 4, FIG. 5, FIG. 6, FIG. 7, FIG. 8, FIG. 9, FIG. 10, FIG. 11, and FIG. 12, example screen images (or “screen shots”) are provided to illustrate in more detail aspects of the method of FIG. 3 including aspects of a method of price presentation. Each of the screen shots shown in FIG. 4, FIG. 5, FIG. 6, FIG. 7, FIG. 8, FIG. 9, FIG. 10, FIG. 11, and FIG. 12 can be considered examples of web pages or other images shown on ones of the I/O device(s) 203 of the sales representative computer 112 and the sales management computer 114, such as video displays thereof, during different steps of the method shown in FIG. 3. Nevertheless, although it is envisioned that the screen shots shown in FIG. 4, FIG. 5, FIG. 6, FIG. 7, FIG. 8, FIG. 9, FIG. 10, FIG. 11, and FIG. 12 can be displayed for example by the sales representative computer 112 or the sales management computer 114 as described further below, it should be appreciated that the present disclosure also encompasses additional embodiments and implementation in which any one or more of these screen shots (or images) can be displayed in other manners by those computers or by one or more other computers of the system 100 (e.g., the consumer computer(s) 104) or otherwise.

FIG. 4 particularly shows an example of a Project Summary screen shot 400 that can be displayed by the sales representative computer 112 when operating as an estimation system in accordance with the third step 306. As mentioned with respect to the third step 306, the Project Summary screen shot 400 displays an overview of various estimate/scope information that pertains to a home improvement project having a project number 402 (in this example, “22742”). The Project Summary screen shot 400 particularly includes a description of the project in an “Included” section 404, which particularly can include descriptions of one or more products that are included in the project (which in this example include a “Bathroom”), related description, a quantity number of each included product, a unit signifier, a unit price, and a total price (in this example, additionally there is also an include subtotal price listing and a total price listing). An add line item button 406 is also provided that, if selected, makes it possible for additional products or information to be listed to the “Included” section 404.

Additionally, the Project Summary screen shot 400 also includes a “Payment Terms” section 408 (which in this example shows that the total price is to be paid in four portions of $2000, $6000, $6000, and $6000, respectively, at the times of acceptance, ordering, half completion, and full completion, respectively). An edit button 410 is also provided as part of the “Payment Terms” section 408 that, if selected, makes it possible for the manner of payment and amount(s) to be paid at different times to be adjusted. Further, the Project Summary screen shot 400 also includes a “Payment Estimator” section 412 having an estimated start date 414 field and an estimated end date field 416 that can be populated with appropriate dates. Additionally, the Project Summary screen shot 400 provides a sales representative identity listing 418 (e.g., “Chris Thornberry”) concerning the sales representative user who logged into the system and entering information into the estimation system (e.g., into the “Included” section 406 and the “Payment Terms” section 408).

Further, the Project Summary screen shot 400 includes a sidebar 420 providing a customer identity listing 422 (e.g., “John Smith”) and, below the customer identity listing, a series of selectable customer details options 424 concerning various types of information that is available and can be reviewed/displayed regarding the identified customer—these include, in the present embodiment, options regarding general information, appointments, inspection, tools, photos, documents, measurements, history, and notes. Further, the sidebar 420 includes selectable company information options 426 that, in this example, include options regarding presentations and design tools. Additionally as shown, the Project Summary screen shot 400 includes a plurality of additional selectable buttons 428. One of the additional selectable buttons 428 is a “$Present” button 430 that, when selected, will cause the sales representative computer 112 to enable the price presentation mode of operation as mentioned in the fourth step 308.

Referring to FIG. 5, when the price presentation mode of operation is enabled, then a Price Presentation screen 500 is displayed by sales representative computer 112. The Price Presentation screen 500 of FIG. 5 is shown to be configured in one example manner, and FIG. 5 highlights several of the configurable aspects or elements of the Price Presentation screen. More particularly as shown, the Price Presentation screen 500 includes a slide/drop title 501, which in the present example is a “Monthly Promo” slide/drop title. Also, the Price Presentation includes a selectable rounding setting (which can be defaulted to either enabled or disabled) 502. In the present example, the rounding setting is set to the nearest $100 level in terms of the displaying of the total price of the home improvement project. Further, in the present example, pre-selected discount(s) 503 are displayed. In the present example, a “Friends and Family” discount of 3% off of the sale price has been specified, and consequently the total price of the home improvement project is shown as having been reduced from $20,000 to $19,400 (with a Total Savings of $600 also being displayed).

Additionally, the Price Presentation screen 500 shows several different pricing options and particularly in this regards includes each of a cash option window (or Title for Cash Card) 504, a “same as cash” window (or Title for Same as Cash (or Promotional Pricing) Card) 505, and a payment range window (Title for Payment Range (or Traditional Financing) Card) 506. Within the cash payment option shown in the cash option window 504, a payment terms section (Payment Terms for Cash Payment Option) 507 is provided. The payment terms section 507 in this example shows payment terms that correspond to the Payment Terms section 408 of FIG. 4, except that each of the listed amounts is discounted by the pre-selected discount(s) 503, which in this example again is a 3% discount (thus, the payment amounts shown are $1940, $5820, $5820, and $5820, respectively, to be paid at the times of acceptance, ordering, half completion, and completion, respectively). Also, within the “same as cash” window 505, there is a down payment amount section 508 (which in this embodiment is listed as zero), and also an additional section 509 showing Same as Cash (or Promotional Pricing) term options (which in this embodiment is shown to be 6 months).

Further, with the payment range window 506, there is provided a Payment Range section 510, which in the present example is based on minimum/maximum (e.g., minimum payment/maximum payment options, which in the present example are shown to represent a range of payment options ranging from a minimum payment amount of $243/month to a maximum payment amount of $388/month). Additionally, Price Presentation screen 500 in the present example includes several additional buttons including discreetly placed buttons 511 that allow for movement between configured slides/drops, and selection buttons 512 associated with the cash option window 504, the “same as cash” window 505, and the payment range window 506 allowing the sales representative user (or other person interacting with the sales representative computer 112) to select the options presented in any of the cash option window, the “same as cash” window, and the payment range window, respectively.

Turning to FIG. 6 and FIG. 7, as previously mentioned in regard to the first step 302 of the method of FIG. 3, a home improvement contractor typically has a sales management configuration (or scope and flow of the sale) and associated series of steps that the contractor mandates be utilized or followed, or prefers to have utilized or followed, by the contractor (or particularly sales representatives thereof) through a closing sequence related to a home improvement project (involving the contractor). Such a series of steps associated with the sales management configuration can be determined by the sales management associated with the contractor, and the series of steps can be referred to as the “Path to Affordability.” These steps can involve numerous (or a few) configurable options including, for example, one or more of those described elsewhere herein. To configure such options, the sales management computer 114 (or alternatively the sales representative computer 112) can present one or more configuration screens including, in the present example, an “Overall Global Configuration” screen 600 as shown in FIG. 6 and also Individual Slides/Drops Settings screen 700 as shown in FIG. 7.

In the present example, each of the Overall Global Configuration screen 600 and the Individual Slides/Drops Settings screen 700 in the present embodiment can be selected (or indirectly selected) in response to a sales management user's selection of a “Financing and Pricing” tab 602 from an overall sales management computer website or application. The Overall Global Configuration screen 600 is the screen (e.g., web page) that initially appears upon the selection to the “Financing and Pricing” tab 602. It will be appreciated that the Overall Global Configuration screen 600 allows for the review and configuration of financing and pricing settings and particularly the price presentations of the Price Presentation screen 500 of FIG. 5. In this regard, the Overall Global Configuration screen 600 include fillable fields 604 in which a user can enter names for the windows or sections that are shown in FIG. 5 such as the cash option window 504, the “same as cash” window 505, and the payment range window 506, and the down payment amount section 508, as well as factors for determining the minimum payment and maximum payment shown in the payment range section 510 (e.g., with a base of about $194, the range of $243 to $388 shown in FIG. 5 can be set using a minimum factor of 1.25 and a maximum factor of 2, respectively).

Also, the Overall Global Configuration screen 600 includes checkable/selectable options 606 regarding items such as whether the price presentation is shown, whether the selectable rounding setting 502 has been selected, and same as cash financing options (e.g., 6, 12, 18, or 24 months) Further, the Overall Global Configuration screen 600 includes toggle options 608 regarding whether certain slides/drop settings are enabled so as to pop up or be available during the price presentation, such as Everyday Low Price, Monthly Promo, or Buy Today slides/drop settings 609 (along with possibly other information such as promotional discounts such as the Friends and Family discount or a Yard Sign discount). Additionally, the Overall Global Configuration screen 600 includes an add slide button 610 that, if selected, allows a user to add additional slides/drop settings, and a save changes button 612 that allows for selected specifications to be saved for future use during operation in a price presentation mode of operation (e.g., entered at the fourth step 308).

As for FIG. 7, one or more of the specifications or options shown on the Overall Global Configuration screen 600 can be modified by opening one or more editing windows or slides, one example of which is shown as the Individual Slides/Drops Setting screen 700. The Individual Slides/Drops Setting screen 700 shown in FIG. 7 particularly includes an editing pop-up window 702 that allows for aspects of the “Buy Today” one of the slides/drop settings 609 to be set. The Individual Slides/Drops Setting screen 700 and particularly the pop-up window 702 thereof can appear, for example, when a sales representative user selects a button on the Overall Global Configuration screen 600 such as the add slide button 610.

As illustrated, the editing pop-up window 702 shows that the “Buy Today” option is enabled, with a selectable option 704 being checked. Also, a Title for the screen is set by populating a field 706 with the label “Buy Today”, and Cash Payment Term is set by selecting “Option 2” from a drop down menu 708. Further, two discounts (the “Friends and Family” discount and the “Yard Sign” discount) 709 are shown to have been selected from a drop down menu 710. Options/specifications that are selected by the Individual Slides/Drops Settings screen 700 regarding what will appear as the “Buy Today” slide/drop setting 609 can be saved by the pressing of a save button 712 (which adjoins a cancel button, which can be pressed to cancel all inputs regarding the slide/drop setting).

Assuming that appropriate ones of the Individual Slides/Drops Settings have been specified by way of Individual Slides/Drops Setting screens such as the Individual Slides/Drops Setting screen 700, then a sales representative user can present the information associated with (or included on) one or more of those Individual Slides/Drops Setting screens as part of a price presentation, during the price presentation mode, when working to secure a contact with a customer/consumer regarding a home improvement project. In this regard, FIG. 8, FIG. 9, and FIG. 10 are provided as examples of Individual Slides/Drops Settings screens that can be presented on the sales representative computer 112 as part of a price presentation during the price presentation mode, as begun at the fourth step 308 and particularly as implemented by the prescribed sales and closing process referred to in the sixth step 312. The sequence of FIG. 8, FIG. 9, and FIG. 10 collectively also is intended to serve as an example of how a price presentation can proceed in accordance with a prescribed closing sequence, as established by a sales management configuration (scope or flow), such as that discussed above with respect to the first step 302.

More particularly, the sequence of FIG. 8, followed by FIG. 9, followed by FIG. 10 illustrates an example flow of a price presentation of a Home Improvement Contractor named “Bob's Roofing” that proceeds in accordance with a prescribed closing sequence that the owner (e.g., Bob) wants all of his sales representatives to follow when attempting to close a sale. As shown, the prescribed closing sequence shows three different Individual Slides/Drops Setting screens that correspond to three of the slides/drop settings 609 shown in FIG. 6 to be presented in a desired order, namely, a first slide/drop setting screen 800 in FIG. 8 that concerns an Every Day Low Price pricing option, followed by a second slide/drop setting screen 900 in FIG. 9 that concerns a Monthly Promo pricing option, and then followed by a third slide/drop setting screen 1000 in FIG. 10 that concerns a Buy Today pricing option.

With respect to FIG. 8, the first slide/drop setting screen 800 describes the Every Day Low Price pricing option that has particular characteristics, some of which are expressly shown on the first slide/drop setting screen (and some others of which are not). A Description of this pricing option is that the price is good for up to 1 year and, regarding discounts, there are no available discounts when choosing this option (these aspects of the pricing option are not expressly shown on the first slide/drop setting screen 800). As for payment options, the first slide/drop setting screen 800 shows that there each of three payment options, namely, a Cash payment option 802, a Same as Cash payment option 804, and a Payment Range payment option 806.

Further, the first slide/drop setting screen 800 shows that the Cash payment option 802 entails that the customer will pay cash and, more particularly, will pay 30% of the purchase price upon acceptance and 70% of the purchase price upon completion. In this example, in which the full purchase price is $20,000, the 30% payment upon acceptance amount is $6000 and the 70% payment upon completion amount is $14,000. Also, the first slide/drop setting screen 800 shows that the Same as Cash payment option 804 entails that the customer can choose from an option of 6 Months Same as Cash. Further, the first slide/drop setting screen 800 shows that the Payment Range option 806 allows for estimated monthly payments for traditional financing based upon a 1.2% to 2.0% payment factor. As illustrated, based upon the total amount of $20,000 and with $0 down payment, this would result in anywhere from a $250/month to a $400/month monthly payment.

Additionally, with respect to the first slide/drop setting screen 800, each of the Cash payment option 802, the Same as Cash payment option 804, and the Payment Range option 806 includes a respective select button 808 that can be selected if the customer approves of that particular option. If one or more of these options is selected because the respective select button 808 is selected by the sales representative user operating the sales representative computer 112 (in this illustration, the select button 808 associated with the Payment Range option 806 is shown to have been selected), then the pricing presentation can end at that point with that selection having been made. However, if none of the displayed options are selected, then the process advances to the second slide/drop setting screen 900 of FIG. 9 concerning the Monthly Promo pricing option.

With respect to FIG. 9, the second slide/drop setting screen 900 describes the Monthly Promo pricing option that has particular characteristics, some of which are expressly shown on the second slide/drop setting screen (and some others of which are not). A Description of this pricing option is that the price is good for 30 days (this aspect of the pricing option is not expressly shown on the second slide/drop setting screen 900). Regarding discounts, there is a 3% Friends and Family Discount (totaling $600 savings, given a total purchase price of $20,000) available when selecting this option, as shown at a location 901. As for payment options, the second slide/drop setting screen 900 shows that there each of three payment options, namely, a Cash payment option 902, a Same as Cash payment option 904, and a Payment Range payment option 906.

Further, the second slide/drop setting screen 900 shows that the Cash payment option 902 entails that the customer will pay cash and, more particularly, will pay 30% of the purchase price upon acceptance and 70% of the purchase price upon completion. In this example, in which the full purchase price is $19,400 ($20,000 minus the 3% discount), the 30% payment upon acceptance amount is $5820 and the 70% payment upon completion amount is $13,580. Also, the second slide/drop setting screen 900 shows that the Same as Cash payment option 904 entails that the customer can choose from an option of 6 Months Same as Cash. Further, the second slide/drop setting screen 900 shows that the Payment Range option 806 allows for estimated monthly payments for traditional financing based upon a 1.2 to 2.0 payment factor. As illustrated, based upon the total amount of $19,400 and with $0 down payment, this would result in anywhere from a $243/month to $388/month monthly payment.

Additionally, with respect to the second slide/drop setting screen 900, each of the Cash payment option 902, the Same as Cash payment option 904, and the Payment Range option 906 includes a respective select button 908 that can be selected if the customer approves of that particular option. If one or more of these options is selected because the respective select button 908 is selected by the sales representative user operating the sales representative computer 112 (in this illustration, the select button 908 associated with the Payment Range option 906 is shown to have been selected), then the pricing presentation can end at that point with that selection having been made. However, if none of the displayed options are selected, then the process advances to the third slide/drop setting screen 1000 of FIG. 10 concerning the Buy Today pricing option.

With respect to FIG. 10, the third slide/drop setting screen 1000 describes the Buy Today pricing option that has particular characteristics, some of which are expressly shown on the third slide/drop setting screen (and some others of which are not). A Description of this pricing option is that the price is good for today only (this aspect of the pricing option is not expressly shown on the third slide/drop setting screen 1000). Regarding discounts, there is a 3% Friends and Family Discount and as well as a Buy Today Discount of $1,000 (totaling $1,600 in total savings given an initial price of $2000) available when selecting this option, as shown at a location 1001. As for payment options, the third slide/drop setting screen 1000 shows that there each of three payment options, namely, a Cash payment option 1002, a Same as Cash payment option 1004, and a Payment Range payment option 1006.

Further, the third slide/drop setting screen 1000 shows that the Cash payment option 1002 entails that the customer will pay cash and, more particularly, will pay 30% of the purchase price upon acceptance and 70% of the purchase price upon completion. In this example, in which the full purchase price is $18,400 ($20,000 minus the 3% discount, additionally minus $1000), the 30% payment upon acceptance amount is $5520 and the 70% payment upon completion amount is $12,880. Also, the third slide/drop setting screen 1000 shows that the Same as Cash payment option 1004 entails that the customer can choose from an option of 6 Months Same as Cash. Further, the third slide/drop setting screen 1000 shows that the Payment Range option 1006 allows for estimated monthly payments for traditional financing based upon a 1.2 to 2.0 payment factor. As illustrated, based upon the total amount of $18,400 and with $0 down payment, this would result in anywhere from a $230/month to $368/month monthly payment.

Additionally, with respect to the third slide/drop setting screen 1000, each of the Cash payment option 1002, the Same as Cash payment option 1004, and the Payment Range option 1006 includes a respective select button 1008 that can be selected if the customer approves of that particular option. If one or more of these options is selected because the respective select button 1008 is selected by the sales representative user operating the sales representative computer 112 (in this illustration, the select button 1008 associated with the Payment Range option 1006 is shown to have been selected), then the pricing presentation can end at that point with that selection having been made. Indeed, in this example, the example customer here (“John Smith”) has selected the payment range option of $230-$368 and so the sales representative user has clicked the select button 1008 on the Payment Range option (or Payment Range Card) 1006. Alternatively, however, if none of the displayed options are selected, then the process concludes with no pricing option having been selected.

Referring next to FIG. 11 and FIG. 12, respectively, a first additional screen shot 1100 and a second additional screen shot 1200 respectively are provided to illustrate how an Integrated Finance Application can be employed as part of the method of FIG. 3. As already described above with reference to FIG. 3, assuming that the prescribed sales and closing process mentioned with reference to the sixth step 312 is completed, then the method proceeds through the steps leading up to the eleventh step 322. If, at the eleventh step 322 the finance option is selected, then the method further advances through the thirteenth step 326, the fourteenth step 328, and the fifteenth step 330, respectively, which (as described above) involve assembling information for the finance application, pre-filling that finance application, and completing that finance application, respectively.

The first additional screen shot 1100 of FIG. 11 particularly illustrates how the system (e.g., the sales representative computer 112) subsequently brings up an Integrated Finance Application window 1102, in which information appropriate to the flow and details of the Integrated Finance Application are entered into data input fields 1104. Upon entry of appropriate information into the data input fields 1104 (in this example, a “Kiosk” is specified as a method, and “Roofing” is specified as a Product), a submit button 1106 can be selected (e.g., clicked on).

Further, the second additional screen shot 1200 of FIG. 12 illustrates how, upon the submit button 1106 being selected, the user is redirected to the Finance Application Applicant Information form 1202, which also can be displayed by the sales representative computer 112. As shown, the Finance Application Applicant Information includes numerous data fields 1204 in to which various information can be entered. In accordance with the fourteenth step 328 of FIG. 3, several of the data fields 1204 will already appear pre-filled with a variety of types of information from the estimation platform, which was previously saved to prevent the need for duplicated data entry. For example, applicant name fields 1206, applicant email address field 1208, and applicant geographic address fields 1210 in the present example are shown to be prepopulated with appropriate example information associated with an example applicant (John Smith). Additionally in accordance with the fifteenth step 330, additional ones of the data fields 1204 can be populated by the sales representative user interacting with the sales representative computer 112 (or, in some embodiments or circumstances, by a customer/consumer).

It should be appreciated that, upon completion of the finance application (e.g., by completion of the Finance Application Applicant Information form 1202), financing such as by way of one or more loans can be pursued by the financing platform, as described above in regard to the fifteenth step 330, sixteenth step 332, and seventeenth step 334 of FIG. 3. Financing particularly can be arranged by interactions between the sales representative computer 112 (or sales management computer 114, or other one of the contractor computer(s) 103) and one or more of the lending computer(s) 102 and/or the transaction facilitator computer(s) 101. When financing has been secured, a contract can be finalized and executed regarding the sale relating to the home improvement project and the financing thereof. The finalization and execution of the contract can also be achieved by the display of one or more screen images or screen shots shown the contract and also possibly electronic signature/execution of said contract.

Notwithstanding the above description, the present disclosure is intended to encompass numerous embodiments including those disclosed herein as well as a variety of alternate embodiments. For example, although the above discussion particularly envisions the implementation of a system and method for facilitating sales or presentations regarding pricing information or options (and/or related consumer lending) in the context of home improvement projects, the present disclosure envisions and encompasses other systems and methods for facilitating sales or presentations regarding pricing information or options (and/or related lending) in the other contexts involving, for example, other projects or purchases by consumers, or projects or purchases by other types of parties (e.g., by businesses or corporate entities).

Each and every document cited in this present application, including any cross referenced or related patent or application, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Unless expressly indicated to the contrary, the numerical parameters set forth in the present application are approximations that can vary depending on the desired properties sought to be obtained by a person of ordinary skill in the art without undue experimentation using the teachings disclosed in the present application. Modifications and other embodiments will be apparent to a person of ordinary skill in the applicable arts, and all such modifications and other embodiments are intended and deemed to be within the scope of the present invention.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A method for facilitating a sale concerning a home improvement project of interest to a first consumer, the method comprising:
providing a first computer including at least one processing device and at least one memory device, wherein the first computer is operated by a contractor company and is configured to communicate with one or more other computers by at least one internet-based communication link;
receiving first input information from a sales representative user at the first computer concerning an estimate or scope of the home improvement project;
determining a plurality of pricing or payment options based upon the first input information;
causing the plurality of pricing or payment options to be presented on a screen of either the first computer or a second computer operated by the first consumer;
receiving second input information indicating that the first consumer has agreed to a first one of the pricing or payment options of the plurality of pricing or payment options; and
taking at least one action to finalize an agreement relating to the sale concerning the home improvement project, wherein the agreement is based at least in part upon the first one of the pricing or payment options.

2. The method of claim 1, wherein the estimate or scope of the home improvement project is determined in accordance with a sales management configuration including a defined sale scope or flow pertaining to the contractor company, as determined by one or more sales managerial personnel of the contractor company.

3. The method of claim 2, wherein the first computer receives at least some information concerning the defined sale scope or flow from a second computer, wherein the first computer is a sales representative contractor computer and the second computer is a sales management contractor computer.

4. The method of claim 3, wherein the sales management configuration includes or is based upon a flow chart or schematic uploaded into at least one memory device of the sales management contractor computer.

5. The method of claim 3, wherein the sales management configuration includes at least one of a software program or a workflow management system that is or are programmed into at least one memory device of the sales management contractor computer.

6. The method of claim 3, wherein the determining of the plurality of pricing or payment options is performed by a price presentation module in accordance with the sales management configuration.

7. The method of claim 6 wherein, if a need or desire arises to consider an alternate pricing or payment option that is inconsistent with the sales management configuration, the first computer provides a signal for receipt by the second computer indicating a request that a sales management override to the sale management configuration be granted.

8. The method of claim 2, wherein the sales management configuration prescribes that one or more of an everyday low price option, a buy today option, and a monthly promotion option should be presented to the first consumer.

9. The method of claim 1, wherein the plurality of pricing or payment options that are caused to be presented on the screen include a cash payment option, a same as cash or promotional pricing payment option, or a payment range option.

10. The method of claim 9 wherein, when the plurality of pricing or payment options are caused to be presented on the screen, the screen also displays one or more of:
a) one or more selectable options concerning one or more pre-selected discounts;
b) first payment terms for the cash payment option;
c) a down payment amount;
d) second payment terms for the same as cash or promotional pricing payment option; or
e) a payment range based on minimum or maximum options for the payment range option.

11. The method of claim 1, wherein the at least one action includes communicating with a financing platform to obtain lending for or financing of the sale concerning the home improvement project.

12. A system for performing the method of claim 11, wherein the system includes the first computer operated by the contractor company, and a second computer operated by a transaction facilitator company that at least in part serves or provides the financing platform, and wherein the first computer includes a mobile device.

13. A system for facilitating a sale concerning a home improvement project of interest to a first consumer, the system comprising:
at least one contractor computer including
a sales management computer having a first processing device and a first memory device;
a sales representative computer having a second processing device and a second memory device,
wherein the sales management computer and sales representative computer are configured to engage in communications therebetween, and
wherein the sales representative computer includes a video display,
at least one communication linkage by which the at least one contractor computer is configured to communicate with additional computers including at least one consumer computer and at least one lending company computer,
wherein the sales management computer is programmed to include a sales management configuration, and configured to communicate either the sales management configuration or instructions based upon the sales management configuration for receipt by the sales representative computer, and
wherein the sales representative computer is configured to display on the video display, in accordance with the sales management configuration or the instructions based upon the sales management configuration, a plurality of screen images to facilitate the sale concerning the home improvement project.

14. The system of claim 13, wherein the sales management configuration includes or is determined at least in part by at least one of a software program or a workflow management system that is or are programmed into the first memory device of the sales management computer.

15. The system of claim 14, wherein at least a first one of the plurality of screen images is configured to enable an estimate or scope of the home improvement project to be built in accordance with the sales management configuration.

16. The system of claim 15, wherein the sales representative computer includes or is configured to operate in accordance with a price presentation module in a manner that is consistent with the sales management configuration, and wherein at least a second one of the plurality of screen images is configured to present a plurality of pricing or payment options in accordance with or as directed by the price presentation module.

17. The system of claim 16, wherein the sales management configuration prescribes that one or more of an everyday low price option, a buy today option, and a monthly promotion option should be presented for consideration by the first consumer.

18. The system of claim 17, wherein the plurality of pricing or payment options that are caused to be presented on the video display include a cash payment option, a same as cash or promotional pricing payment option, or a payment range option.

19. The system of claim 18, further comprising a financing platform provided by either the sales representative computer or the sales management computer, wherein a financing application provided by the financing platform is at least partly pre-filled automatically by the sales representative computer or the sales management computer with first financing-related information, and additionally a financing application window is displayed by the sales representative computer to allow for an input of second financing-related information, so as to complete a finance application.

20. The system of claim 19, wherein the at least one contractor computer communicates with the at least one lending company computer to provide the finance application to the at least one lending company computer so that a financing arrangement pertaining to the home improvement project is completed.
